(19) United States
(12) Patent Application Publication
(10) Pub. No.: US 2016/0294230 A1
(43) Pub. Date: Oct. 6, 2016

(54) ALTERNATING-CURRENT FULL MAGNETIC POWER MACHINE

(71) Applicant: Xian ZHANG, Nanjing (CN)

(72) Inventors: Xian ZHANG, Nanjing (CN); Wenjie ZHANG, Nanjing (CN); Xiaoyan ZHU, Nanjing (CN)

(73) Assignee: Xian ZHANG, Nanjing (CN)

(21) Appl. No.: 15/175,404

(22) Filed: Jun. 7, 2016

(30) Foreign Application Priority Data
Jan. 14, 2016 (CN) 201610028191.1
Mar. 31, 2016 (CN) 201610206343.2

(51) Int. Cl. H02K 1/17; H02K 3/46; H02K 5/16; H02K 1/27

(52) U.S. Cl. CPC H02K 1/17; H02K 1/27; H02K 3/46; H02K 5/161

(57) ABSTRACT

An alternating-current full magnetic power machine includes a stator and a rotor. The stator includes a stator iron core and multiple coil windings that are built in a cable trough of the stator iron core in sequence, a pole of the stator iron core is provided with a groove, a stator the permanent magnet is disposed in the groove, a metal-plate of a fence-like mesh structure is fixed on a pole surface, and multiple stator composite magnetic heads made of the stator the permanent magnet and the metal-plate are disposed in the coil windings, the pole, and the groove. The rotor includes a rotor iron hoop made of a compound material, a non-magnetic material surface of the rotor iron hoop is provided with multiple rotor permanent magnets, and a metallic copper or an aluminous squirrel cage closed frame is disposed on a rotor permanent magnet surface.

### BACKGROUND

1. Technical Field

The present invention relates to a permanent magnetic electrical machine that converts magnetic energy into mechanical energy and relates to the field of rare earth permanent magnet the magnetic energy conversion technologies, and in particular, to an alternating-current full magnetic power machine.

2. Related Art

Currently, the research on equipment that converts magnetic energy of a rare earth neodymium-iron-boron alloy super permanent magnet into mechanical energy is extremely urgent. In a process of researching an entire system, a new technical problem is constantly put forward. Although energy saving of a rotor of a permanent magnetic motor is obvious by means of a rare earth permanent magnet, an excitation coil is still used on a stator. As a result, electricity consumption of the stator is not reduced, heat dissipation and energy consumption of the stator are extremely large, and an unsecure problem that a winding is burnt up because of overheating often occurs. Therefore, an energy-saving solution needs to be continued and further researched, so as to ensure that a mechanical unit is securer. For the foregoing problem, research may first be carried out on an existing alternating-current permanent magnetic motor. A key point is to use a permanent magnet also on the stator, so that a magnetic field effect occurs between the permanent magnet on the stator and a permanent magnet on the rotor. In addition, an electrical magnetic field generated by the winding appears, and overlaps a permanent magnetic field, to form a changing composite magnetic field. The generated magnetic field thrust enables the rotor to rotate.

### SUMMARY

For the foregoing problem, the present invention provides a green, secure, new-structure, and reliable alternating-current full magnetic power machine, which uses a powerful principle that like polarities repel but opposite polarities attract of a rare earth permanent magnet and a phenomenon that the magnetic field may be overlapped. In addition, the alternating-current full magnetic power machine further uses a characteristic that an alternating-current power supply generates a rotating magnetic field in a motor stator coil and a phenomenon that a metal squirrel cage-type frame of a corresponding motor rotor rotates under stress because of getting cut by a magnetic curve in an alternating magnetic field. On the basis of remaining the foregoing structural characteristic of the conventional alternating-current permanent magnetic motor, an improvement made by the present invention is: multiple rotor permanent magnets are added to and disposed on a surface of a motor rotor iron hoop, and form a new rotor composite structure with the squirrel cage-type frame disposed on a rotor permanent magnet surface. An objective is to enable a driving torque to obviously increase because of the participation of a permanent magnet in the new rotor composite assembly. In addition, a pole surface of the stator iron core surrounded by the motor stator coils is provided with a U-shaped groove, multiple stator permanent magnets are disposed in the groove, the stator coils, the stator iron core pole surface that is surrounded by the stator coils, the groove, the permanent magnet disposed in the groove form a composite magnetic head, and further form a new stator composite structure. A shape and a size of a permanent magnet in each stator groove and a shape and a size of a permanent magnet in another groove are adjusted and determined according to a strength rule of a magnetic field generated by a connecting rod diagram of wire distribution of a winding, which is beneficial to overall dynamical coordination of the magnetic field. Design and manufacture of the alternating-current full magnetic power machine follow an alternating-current motor standard, and in addition, an advantage and a characteristic of the magnetic field of the permanent magnet of the alternating-current full magnetic power machine are added. The design enables a conventional alternating-current motor to be converted into an alternating-current magnetic power machine. A basic principle and structure of the conventional alternating-current motor are remained, a design and manufacturing rule of the alternating-current motor is followed, in addition, a strong permanent magnet is brought in, and a rotor structure and a stator structure are added, so as to form a new rotor composite structure and a new stator composite structure. The alternating-current full magnetic power machine mainly works by depending on the magnetic energy. The alternating-current power supply changes to bear a control function of adjusting and controlling the magnetic field and a turning direction, so that an inductive coil changes from a conventional working function into a function of interfering with a constant magnetic field, so as to greatly save electricity consumption, reduce a heat temperature, and reduce a probability of overload and burning up. In addition, the alternating-current full magnetic power machine is secure and environmentally friendly, and an application range is also expanded.

A technical solution provided in the present invention is: an alternating-current full magnetic power machine, including a stator and a rotor, where the stator includes a stator iron core and multiple coil windings that are built in a cable trough of the stator iron core in sequence, a pole of the stator iron core is provided with a groove, a stator the permanent magnet is disposed in the groove, a metal-plate of a fence-like mesh structure is fixed on a pole surface, and multiple stator composite magnetic heads consisting of the stator the permanent magnet and the metal-plate are disposed in the coil windings, the pole, and the groove; and the rotor includes a rotor iron hoop, the rotor iron hoop is made of a compound material, a non-magnetic material surface of the rotor iron hoop is provided with multiple rotor permanent magnets, and a metallic copper or an aluminous squirrel cage closed frame is disposed on a rotor permanent magnet surface.

The alternating-current full magnetic power machine has a rotary housing inner stator type structure or a fixed housing rotary inner pivot type structure. The alternating-current full magnetic power machine of the rotary housing inner stator type structure includes the stator composite magnetic head, an empty mandrel, the rotor iron hoop, a rotor permanent magnet, and a rotating housing. The stator has three phases of independent windings, each winding includes multiple coils, the coils are built in the cable trough of the stator iron core in sequence, the pole surface of the stator iron core surrounded by the coils is provided with a U-shaped groove, the stator permanent magnet is disposed in the groove, there is a void between the stator permanent magnet in the groove and a groove wall, glue is injected into the void for fixation and encapsulation, a stator permanent magnet of a like polarity is disposed in a same groove, a length of the stator permanent magnet is less than a length of the groove, and whether polarities of stator permanent magnets disposed in neighboring grooves are opposite or the same is determined by a pole position of the connecting rod winding diagram; the pole surface of the groove is fixed with a metal-plate of a fence-like mesh structure, and the metal-plate has a thickness of 0.3 to 5 mm. another side of the stator iron core is disposed on a stator iron hoop, a wheel center of the stator iron hoop is provided with the empty mandrel, a central spindle of the empty mandrel is provided with a threading hole, two ends of the empty mandrel are provided with a bearing and are connected to a rotating housing by using the bearing, the rotating housing covers an outside of the rotor iron hoop, and in addition, one side-end of the rotating housing is fixedly connected to an output shaft; and the rotor iron hoop is made of the compound material, a non-magnetic material surface of the rotor iron hoop is provided with multiple permanent magnets, there is a metallic copper or an aluminous squirrel cage closed frame on the permanent magnet surface forming a rotor permanent magnet, there is an air gap between the rotor permanent magnet and a stator permanent magnet surface, and when the stator coil is conducted, strength of an inductive magnetic field generated by the stator iron core pole surface is not greater than coercivity of the surrounded stator permanent magnet. Neighboring rotor permanent magnets on the rotor form a closed circle or a fold circle. If a fold circle is formed, the rotor permanent magnets are of opposite polarities. Side lengths of two rotor permanent magnets of each unit are not equal, and a length of each rotor permanent magnet is not equal to a length of a corresponding stator permanent magnet. Widths of multiple composite magnetic heads of like polarities on the stator are greater than or equal to two times of a width of a single rotor permanent magnet on the rotor. Sizes of rotor permanent magnets of like polarities are the same, and sizes of rotor permanent magnets of opposite polarities are different. A protection ferrule at a location of the rotor squirrel cage frame is made of a non-magnetic material, there is an air gap between the protection ferrule and the stator permanent magnet surface, and a driving torque is obviously increased because of the participation of a permanent magnet in the rotor composite assembly. It can be known from the left-hand rule that after the rotor permanent magnet and a squirrel cage closed frame composite structure is under a side thrust in a rotating magnetic field, an effect is improved. In a static state, a turnplate can rotate freely around the spindle. A quantity of slots of the stator, a shape of a slot, a quantity of coil turns, a line diameter, and a line connection manner, are all conform to a design and manufacturing standard of an alternating-current motor. In addition, a characteristic of a rare earth permanent magnet is shown. When the stator coil is conducted, strength of an inductive magnetic field generated on a pole surface of the stator iron core is not greater than magnetic coercivity data of the permanent magnet. Because of this rule, when passing through the symmetrical three-phase sine wave circular alternating current, the stator composite magnetic head surface instantly generates various different rotating composite magnetic fields:

A. When a magnetic polarity of the stator permanent magnet surface in the groove is N, a stator iron core pole plane surrounding the stator permanent magnet in a coil inductive magnetic field is pole S. Therefore, a magnetic field of the stator composite magnetic head is weakened. A magnetic line points from the pole N of the stator permanent magnet to the pole S of a stator iron core and mainly passes through a metal-plate cover body. A part of the magnetic field is closed and shielded. A magnetic line leaked from the mesh may also be bent. It shows that the magnetic field on the surface is weakened. When an adjustment line diameter and a quantity of turns are in an optimal state and reading on the Gauss Meter is lowered to single digit, it shows that it is an extremely weak magnetic field, which is equivalent to a zero or negative current status of a conventional electrical machine.

B. Similar to A, when the magnetic polarity of the stator permanent magnet surface in the groove is S, the stator iron core pole plane surrounding a permanent magnet in the coil inductive magnetic field is pole N. Therefore, the magnetic field of the stator composite magnetic head is weakened, and it shows an extremely weak magnetic field, which is equivalent to a zero or negative current status of a conventional motor.

C. When the magnetic polarity of the stator permanent magnet surface in the groove is N, the stator iron core pole plane surrounding the stator permanent magnet in the coil inductive magnetic field is pole N. Therefore, the magnetic field of the stator composite magnetic head is strengthened. A mesh-shaped metal-plate cover does not disturb that adding of magnetic lines that are generated at this moment, and it shows an open extremely strong magnetic field, which is equivalent to a positive or high current status of a conventional motor.

D. Similar to C, when the magnetic polarity of the stator permanent magnet surface in the groove is S, the stator iron core pole plane surrounding the stator permanent magnet in the coil inductive magnetic field is pole S. Therefore, the magnetic field of the stator composite magnetic head is strengthened. Magnetic lines are added together, but a direction is opposite to N of like polarities. It shows an extremely weak magnetic field, which is equivalent to a positive or high current status of a conventional motor.

E. When a coil current is zero, the magnetic field of the stator composite magnetic head is a magnetic field of the stator permanent magnet in the groove but still has a strong magnetic field of the stator permanent magnet, thereby improving a vector field energy position of the magnetic field, which is beneficial to a zero-status start.

The foregoing various different rotating composite magnetic fields may analyze, when passing through three-phase alternating-current electricity that absolute values of instant rotating magnetic fields C, D, and E should be greater than absolute values of A and B. which is as a result of that in a situation of inputting same electric power, magnetic energy of the magnetic field may be strengthened because of adding of the stator permanent magnet, thereby improving magnetic vector field and improving an output effect. A stator the rotating composite magnetic field is generated when a three-phase symmetrical power supply is connected. The stator the rotating composite magnetic field senses, by means of an air gap, a rotor squirrel cage closed frame, correspondingly generates an induced electromotive force, and forms a torque with an inductive electromagnetic force on a shaft. The rotor and the stator permanent magnet increase a constant magnetic force of the system. An instantly changed composite magnetic field caused by overlapping of the inductive electromagnetic force and the constant magnetic force is on a new stage. It still keeps a characteristic of conventional three-phase alternating-current frequency power supply. It is the same as a property of the rotating magnetic field that is directly generated by the alternating-current power supply in a conventional electrical machine. They are in a composite magnetic field circular procedure in which an inductive alternating electromagnetic field performs instant modified overlapping on the constant magnetic field of the permanent magnet all the time. Only because an initial rotating direction is changed because of adding of the constant magnetic field, input electricity consumption is reduced, and an amount of an output of magnetic energy is increased. Because an electrical angle, frequency, a quantity of polarities, a quantity of slots, and a line connection manner do not change, as long as inductive electromagnetic strength generated through induction of the stator iron core pole reaches and is not greater than coercivity of the constant magnetic field of the permanent magnet surrounded by the stator iron core pole, the machine is conform to a design requirement. In this way the larger a quantity of turns becomes, the smaller a line diameter is. In current-stable environment, electricity consumption naturally decreases, and a problem of rising temperature is easy to resolve. A function weakened by an electrical energy input decrease is replaced with the magnetic energy of the permanent magnet. In this way, directly working by alternating-current electrical magnetic field is converted into mainly directly working by exchanging interaction of the magnetic field of the permanent magnet. Changing an external connecting rod head may change a rotating direction. There is a star connection manner or a triangle connection manner. The alternating-current power supply usually uses a commercially-available three-phase 380 v 50 Hz power supply. For a direct current, an inverter cluster is used to first change a battery direct current into a single-phase alternating-current electricity, and then change two group of single-phase alternating-current electricity into a matching three-phase alternating-current power supply by using an automatic Wood Bridge balancer AWB. A battery pack is charged by a commercially-available power supply, or is charged by a solar battery, or is charged by a lower-power electric generator driven by an alternating-current magnetic power machine after rectification and voltage regulation. The alternating-current full magnetic power machine of a rotary housing inner stator type structure forms different types because of different connection configuration items of the rotating housing: if a tire is disposed on the rotating housing, a vehiculary stock alternating-current full magnetic power machine is formed; if a gear or a belt pulley is disposed on the rotating housing, a mechanical equipment straight driving force alternating-current full magnetic power machine is formed; and if an output shaft, a support, and a housing shield are disposed on the rotating housing, a spindle output-type alternating-current full magnetic power machine applicable to an ordinary machine and tool is formed. Because a rotary inertia is directly proportional to a radius squared, a rotary inertia of a rotating housing type is greater than that of a pivot type. The stronger an inherent constant magnet of a permanent magnet combination is, the bigger an output of the converted mechanical energy is. The alternating-current full magnetic power machine power supply operates when powered on, and stops operating when the power supply is turned off.

The alternating-current full magnetic power machine of the fixed housing rotary inner pivot type structure includes the stator composite magnetic head, the spindle, the rotor iron hoop, and the rotor permanent magnet, where the rotor iron hoop is made of a compound material. The non-magnetic material surface of the alternating-current full magnetic power machine is provided with multiple rotor permanent magnets, a squirrel cage-type frame is disposed on a rotor permanent magnet surface, and a rotor is formed together. There is a circle of protection ferrule non-magnetic material at a location of the squirrel cage frame of the outer surface of the rotor permanent magnet. There is an air gap between the protection ferrule and the stator permanent magnet surface. The driving torque is obviously increased because of participation of the rotor permanent magnet in the rotor composite assembly. The spindle is disposed in a wheel center of the rotor iron hoop, and two ends are provided with a bearing and are connected to a stator housing by using the bearing. The pole surface of the stator iron core surrounded by the coils is provided with a U-shaped groove, a stator permanent magnet is disposed in the groove, there is a void between the stator permanent magnet in the groove and a groove wall, glue is injected into the void for fixation and encapsulation, a stator permanent magnet of a like polarity is disposed in a same groove, a length of the stator permanent magnet is less than a length of the groove, and whether polarities of stator permanent magnets disposed in neighboring grooves are opposite or the same is determined by a location of the coil winding. The pole surface of groove is fixed with a metal-plate of a fence-like mesh structure. The metal-plate is made of a soft magnetic material. The soft magnetic material is beneficial to smooth operation of a composite magnetic head and a magnetic line. The motor stator three phases of independent windings, each winding includes multiple coils, the multiple coils are built in a cable trough of the stator iron core in sequence, and the stator permanent magnet and the metal-plate that are disposed in the coil winding and the pole groove form multiple stator composite magnetic heads together. Another side of the stator iron core is disposed on a housing inner wall. In operation, a composite magnetic head controlled by alternating-current electricity generates a controllable instant inductive alternating-current electrical magnetic field. In this case, the composite magnetic head has a function of magnetic variation, to implement an effect of reducing magnetic resistance and changing strength of a constant magnetic field. Overlapping interference of like polarities or opposite polarities of the composite magnetic head is beneficial to successful and consistent rotating of the stator and the rotor permanent magnet that are correspondingly disposed on the turnplate under an acting force of the magnetic energy.

The rotating housing of an inner stator type of the alternating-current magnetic power machine forms different types because of different connection configuration items of the rotating housing: if a tire is disposed on the rotating housing, a vehiculary stock alternating-current magnetic power machine is formed; if a gear or a belt pulley is disposed on the rotating housing, a mechanical equipment straight driving force alternating-current magnetic power machine is formed; and if an output shaft, a support, and a housing shield are disposed on the rotating housing, a spindle output-type alternating-current magnetic power machine applicable to an ordinary machine and tool is formed.

The alternating-current magnetic power machine is powered by a commercially-available alternating-current power supply, or is powered by a matching alternating-current power supply that is provided by a battery pack by using a voltage-regulating converter, and the battery pack is charged by a commercially-available power supply, or is charged by a solar battery, or is charged, after rectification and voltage regulation, by an electric generator driven by the alternating-current magnetic power machine. When the alternating-current magnetic power machine supplies power by using a single-phase alternating-current power, a design structure of a single-phase asynchronous split-phase motor is mainly used. The stator winding includes a main winding, a groove on the pole, the stator permanent magnet in the groove, and a starting winding. The rotor includes multiple rotor permanent magnets on the rotor iron hoop and a copper squirrel cage closed frame that is located on the rotor permanent magnet surface.

Beneficial effects of the present invention are as follows: the present invention provides a green, secure, new-structure, and reliable alternating-current magnetic power machine, which uses a powerful principle that like polarities repel but opposite polarities attract of a rare earth permanent magnet. In addition, the alternating-current full magnetic power machine uses a characteristic that a three-phase alternating-current power supply generates a rotating magnetic field in a motor stator coil and a phenomenon that a metal squirrel cage-type frame of a corresponding motor rotor rotates under stress because of getting cut by a magnetic curve in an alternating magnetic field. The advantage and the characteristic of a conventional alternating-current motor of the foregoing structure are remained Improvement of the present invention is: the non-magnetic material surface of the compound material rotor iron hoop is further provided with multiple rotor permanent magnets, and the multiple rotor permanent magnets form a rotor combination with the squirrel cage-type frame disposed on the rotor permanent magnet surface. A driving torque in the rotor composite assembly is increased because of participation of the rotor permanent magnet. The pole surface of the stator iron core surrounded by the stator coils is provided with a U-shaped groove, multiple stator permanent magnets are disposed in the groove, and the stator permanent magnets disposed in the groove, and a metal-plate of a fence-like mesh structure form a stator composite magnetic head. Design and manufacture of the alternating-current full magnetic power machine follow an alternating-current motor standard, and in addition, an advantage and a characteristic of the magnetic field of the permanent magnet of the alternating-current full magnetic power machine are added. The design enables a conventional alternating-current motor to be converted into an alternating-current magnetic power machine. A basic principle and structure of the conventional alternating-current motor are remained, a design and manufacturing rule of the alternating-current motor is followed, based on which, a strong permanent magnet is brought in, and a rotor structure and a stator structure are added, so as to form a new rotor composite structure and a new stator composite structure. After the machine runs for a period of time, a mutual magnetic force of the permanent magnet decays to a degree. The machine can continue being used after a new permanent magnet is used or the original permanent magnet is magnetized. When the machine is used beneath a 380 v voltage, a voltage-regulating converter needs to be configured to provide three-phase alternating-current power supply. When a battery direct-current power supply is used, the battery direct-current power supply needs to be converted into alternating current by using the voltage-regulating converter, to supply power. In this way, a usage range of the alternating-current full magnetic power machine is also expanded a lot. The machine uses a green and environmentally friendly resource, which is approximately zero emission and zero pollution. Usage costs are low and a fault rate is low. The machine can work stably for a long time in airless environment, is widely applied to various power devices, for example, being uses as a power source in special environment and a robot power source, and has excessively high social and economical values.

### BRIEF DESCRIPTION OF THE DRAWINGS

FIG. 1 is a schematic diagram of an inner structure of an alternating-current full magnetic power machine of a rotating housing inner stator type according to the present invention;

FIG. 2 is a cross-sectional view of an inner core of an alternating-current full magnetic power machine of a rotating housing inner stator type according to the present invention;

FIG. 3 is a schematic morphological diagram of a stator composite magnetic head of an alternating-current full magnetic power machine according to the present invention;

FIG. 4 is a schematic diagram of magnetic lines of a magnetic leakage of opposite polarities: poles N to S at a moment when a cross section of a stator composite magnetic head of an alternating-current full magnetic power machine is conducted according to the present invention;

FIG. 5 is a schematic diagram of magnetic lines of a magnetic leakage of opposite polarities: poles S to N at a moment when a cross section of a stator composite magnetic head of an alternating-current full magnetic power machine is conducted according to the present invention;

FIG. 6 is a schematic diagram of magnetic lines of like polarities: poles N to N at a moment when a cross section of a stator composite magnetic head of an alternating-current full magnetic power machine is conducted according to the present invention;

FIG. 7 is a cross-sectional view of an inner core of an alternating-current full magnetic power machine of a fixed housing rotary inner pivot type according to the present invention; and

FIG. 8 is a schematic diagram of connecting rod of single-layer crossing windings of a stator slot 36 and pole 4 (numbers in the diagram merely represent examples of tabs of windings) that are selected and used by an alternating-current full magnetic power machine according to the present invention.

In the figures: 1. Alternating-current full magnetic power machine, 2. Stator composite magnetic head, 3. Winding, 4. Stator iron core, 5. Void, 6. Stator permanent magnet, 7. Stator, 8. Spindle, 9. Stator iron hoop, 10. Air gap, 11. Rotor iron hoop, 12. Squirrel cage frame, 13. Bearing, 14. Protection ferrule, 15. Connecting rod, 16. Rotor, 17. Empty mandrel, 18. Output shaft, 19. Fixed bolt, 20. End cap, 21. Groove, 22. Cable trough, 23. Metal-plate, 24. Rotor permanent magnet, 25. Rotating housing.

### DETAILED DESCRIPTION

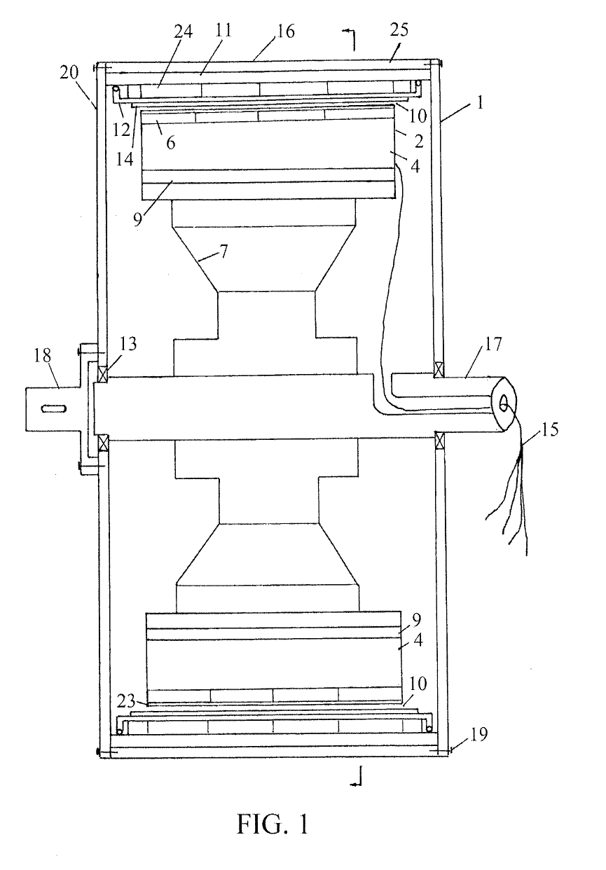

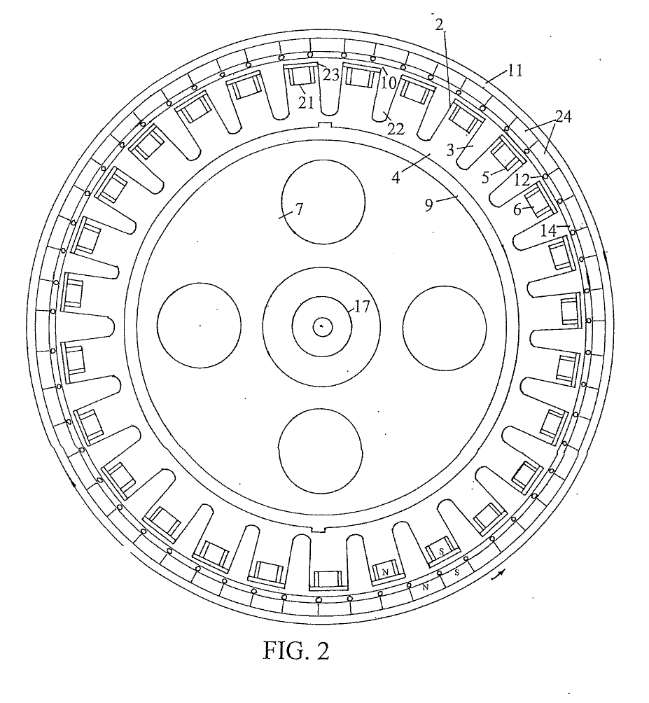

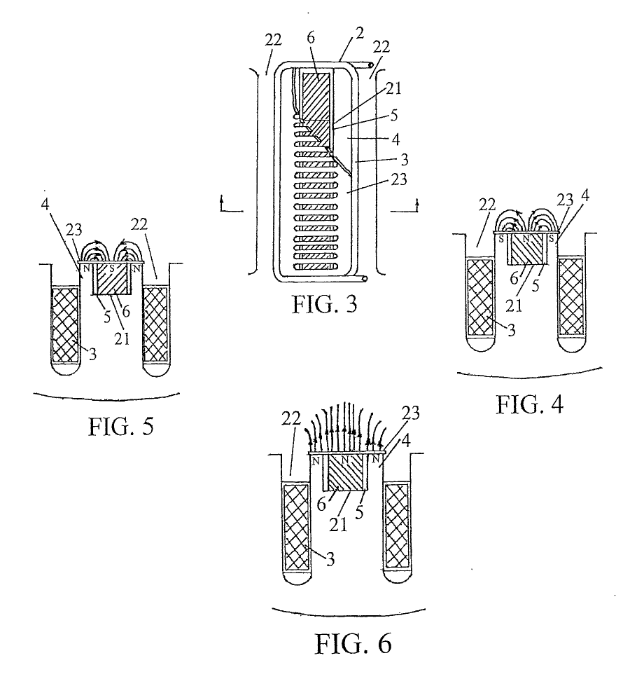

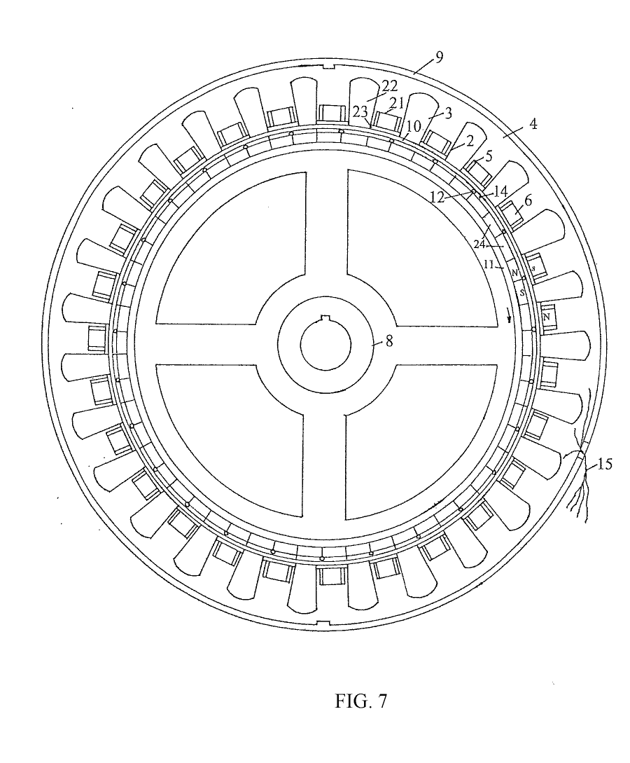

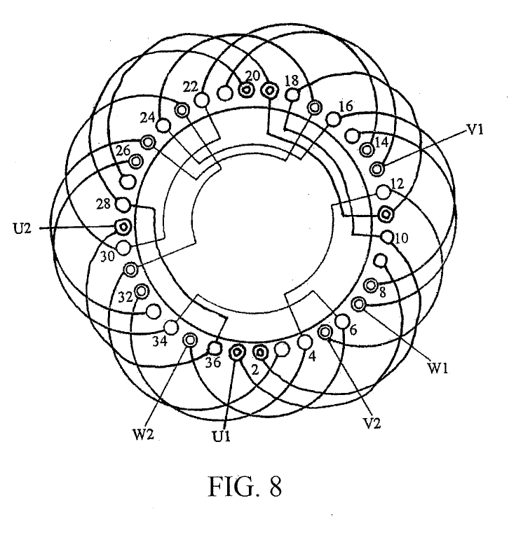

In embodiments of the present invention, referring to the foregoing FIG. 1, FIG. 2, FIG. 3, FIG. 4, FIG. 5, FIG. 6, and FIG. 7, an alternating-current full magnetic power machine 1 uses a three-phase alternating-current power supply. The alternating-current full magnetic power machine has a rotating housing inner stator type or a fixed housing rotary inner pivot type. In research of sample device design of the alternating-current full magnetic power machine 1, in an atlas of a commercially-available motor, a most commonly-used connecting rod diagram of single-layer crossing windings of slot 36 and pole 4 is selected. If a connecting rod diagram of windings above pole 4 is chosen, a rotating speed decreases, but the problem may be resolved by connecting a speed controller. As shown in FIG. 8, which is a schematic diagram of wire distribution and wire connection of the windings, an offset of the three-phase windings is 120 degrees. The rotating housing inner stator type includes a stator composite magnetic head 2 combination, an empty mandrel 17, a rotor combination, and a rotating housing 25. A stator 7 has three phases of independent windings 3, each winding 3 comprises multiple coils, the coils windings 3 are built in a cable trough 22 of a stator iron core in sequence, a pole surface of the stator iron core 4 surrounded by the coils windings 3 is provided with a U-shaped groove 21, multiple stator permanent magnets 6 are disposed in the groove 21, there is a void 5 between the stator permanent magnets 6 and a wall of the groove 21, and glue is injected into the void for fixation and encapsulation, where the stator iron core 4 consists of a silicon steel sheet laminate body. The stator permanent magnets 6 of like polarities are disposed in the same groove 21. Three closely-neighboring groove 21 combinations are of like polarities. Three neighboring grooves 21 are a group. The stator permanent magnets 6 disposed in each group of grooves 21 are of like polarities. Magnetic polarities of neighboring groups are opposite. Locations are determined by the connecting rod FIG. 8. A total length of the stator permanent magnets 6 disposed in the groove 21 should be less than a total length of the grooves 21. In this way, a magnetic leakage can be reduced. The stator permanent magnet is disposed in the groove. The pole surface is fixed with a metal-plate 23 of a fence-like mesh structure. The metal-plate 23 made of soft magnetic material. The soft magnetic material is beneficial to smooth operation of a magnetic line of a stator composite magnetic head 2 in a magnetic road of magnetic fields of opposite polarities. The metal-plate 23 cannot block magnetic road smoothness of the magnetic lines of like polarities, an air gap 10, and a rotor permanent magnet 6. The metal-plate 23 has a thickness of 0.3 to 5 mm. The thickness may be thin but cannot be thick, and meshes may be sparse but cannot be intensive. A selection of a data value of the air gap 10 is in a static state, the air gap can be rotated by hands, that is, the rotor 16 is in a free and rotatable state. Another side of the stator iron core 4 is disposed on a stator iron hoop 9. A wheel center in the stator iron hoop 9 is an empty mandrel 17. A threading hole is at a hollow-core location of the mandrel. Two ends of the stator the empty mandrel 17 are provided with a bearing 13, and are connected to a rotating housing 25 by using the bearing 13. The rotor iron hoop 11 is made of a compound material. A non-magnetic material surface of the rotor iron hoop 11 is provided with multiple rotor permanent magnets 24. A surface of the rotor permanent magnetic 24 is provided with a metallic copper or an aluminous squirrel cage closed frame 12, and a rotor combination is formed. An upgraded version of the rotor combination is to append an additional device that can change a diameter. The upgraded version can effectively improve a torque output. There is a circle of protection ferrule 14 made of a non-magnetic material, or aluminous or chemical fiberglass cloth at a location of a squirrel cage frame 12 on an outer surface of the rotor permanent magnet 24. The air gap 10 is between the protection ferrule 14 and the surface of the stator permanent magnet 6. A driving torque is obviously increased because of participation of the rotor permanent magnet 24 in the rotor combination. A quantity of slots of the stator iron core 4, a shape of a slot, a quantity of turns of the stator coil winding 3, a line diameter, a line connection manner are conform to a design and manufacturing rule of an alternating-current motor, and in addition, satisfies a characteristic of a rare earth permanent magnet. When the stator coil winding 3 is conducted, strength of an inductive magnetic field generated on the pole surface of the stator iron core 4 is not greater than coercivity data of the stator permanent magnet 6. A fixed bolt 19 fixes an end cap 20 on the rotor 16 or the rotating housing.

Another fixed housing rotary inner pivot type of the alternating-current full magnetic power machine 1: a rotor iron hoop 11 made of a compound material, multiple rotor permanent magnets 24 disposed on a non-magnetic material surface of the rotor iron hoop 11 and a squirrel cage closed frame 12 on a surface of the rotor permanent magnet 24 form a rotor combination together. There is a circle of a protection ferrule 14 made of a non-magnetic material at a location of the squirrel cage frame 12 on an outer surface of the rotor permanent magnet 24. There is an air gap 10 between the protection ferrule 14 and a surface of a stator permanent magnet 6. A driving torque is obviously increased because of participation of the rotor permanent magnet 24 in a rotor combination. The spindle 8 is disposed in a wheel center of the rotor iron hoop 11, and two ends of the spindle are provided with a bearing 13 and are connected to a stator fixed housing by using the bearing 13. In the housing, a pole surface of a stator iron core 4 surrounded by stator coil windings 3 is provided with a U-shaped groove 21. Multiple stator permanent magnets 6 are disposed in the groove 21. There is a void 5 between the stator permanent magnets 6 and a wall of the groove 21, and glue is injected into the void for fixation and encapsulation. The stator permanent magnets 6 of like polarities are disposed in the same groove 21. Whether polarities of the stator permanent magnets 6 disposed in neighboring grooves 21 are opposite or the same is determined by a design location of wire distribution according to a connecting rod of windings of coil windings 3 in FIG. 8. The surface of the stator permanent magnet 6 disposed on the surface of the groove 21 and in the groove 21 is fixed with a metal-plate 23 of a fence-like mesh structure. The metal-plate 23 is beneficial to smooth operation of a magnetic road of a magnetic line of a stator composite magnetic head 2. The stator has three phases of independent windings, each winding includes multiple coils, the multiple winding coils are built in a cable trough 22 of the stator iron core 4 in sequence. The stator coil winding 3, the groove 21 on the pole surface, and the stator permanent magnet 6 disposed in the groove 21 form a stator composite magnetic head 2 together. Another side of the stator iron core 4 is disposed in an inner wall of a stator iron hoop 9. In operation, a composite magnetic head 2 controlled by alternating-current electricity generates a controllable instant inductive alternating-current electrical magnetic field. In this case, the composite magnetic head 2 has a function of magnetic variation, to implement an effect of reducing magnetic resistance and changing strength of a constant magnetic field. Overlapping interference of like polarities or opposite polarities of the composite magnetic head 2 is beneficial to successful and consistent rotating of the stator and the rotor permanent magnet that are correspondingly disposed on the turnplate under an acting force of the magnetic energy. An air gap 10 is a little greater than an air gap value of a conventional motor. Therefore, an abrasions rate is enabled to decrease. A direction may be exchanged by exchanging a connecting rod head of an outer connecting rod 15. There is a star connection manner or a triangle connection manner. An alternating-current power supply uses a commercially-available three-phase 380 v 50 Hz power supply. When a voltage is lower than 380 v, a voltage-regulating converter needs to be configured to provide a three-phase alternating-current power supply. When a battery direct-current power supply is used, two groups of single-phase alternating-current electricity is changed into a matching three-phase alternating-current power supply by using an automatic Wood Bridge balancer AWB. The battery pack is charged by a commercially-available power supply, or is charged by a solar battery, or is charged, after rectification and voltage regulation, by an electric generator driven by the alternating-current magnetic power machine 1. The alternating-current full magnetic power machine 1 needs to be configured with an axial fan for heat dissipation. In addition, the alternating-current full magnetic power machine 1 of a rotary housing inner stator type structure forms different types because of different connection configuration items of the rotating housing: if a tire is disposed on a rotor 16 of the rotating housing, a vehiculary stock alternating-current full magnetic power machine 1 is formed; if a gear or a belt pulley is disposed on the rotor 16 of the rotating housing, a mechanical equipment straight driving force alternating-current full magnetic power machine 1 is formed; if an output shaft, a support, and a housing shield are disposed on the rotor 16 of the rotating housing, a spindle output-type alternating-current full magnetic power machine 1 applicable to an ordinary machine and tool is formed.

In implementation of the present invention, because in a static state, a turnplate needs to reach a condition of free rotation, a value of an air gap 10 is relatively large in a static state. Therefore, an applied moment of a magnetic field is affected. Therefore, a matching apparatus properly changing with a perimeter of a rotor iron hoop 11 should be added, so as to achieve an effect of an adjustable perimeter, shrinking a value of a dynamic air gap 10, and improving a driving torque. There are relatively many solutions, which may be manual, mobile, electric, and the like. Content mostly needs to be described separately. The present invention merely describes a status of a layout of a radial permanent magnet, and content of a status of a layout of a tangential permanent magnet needs to be described separately.

The above embodiments are merely preferred embodiments of the present invention, which cannot limit the implementation scope of this application. Alterations and modifications made according to the scope of this application shall belong to the scope included the present invention.

What is claimed is:

1. An alternating-current full magnetic power machine, comprising a stator and a rotor, wherein the stator comprises a stator iron core and multiple coil windings that are built in a cable trough of the stator iron core in sequence, a pole of the stator iron core is provided with a groove, a stator permanent magnet is disposed in the groove, a metal-plate of a fence-like mesh structure is fixed on a pole surface, and multiple stator composite magnetic heads consisting of the stator permanent magnet and the metal-plate are disposed in the coil windings, the pole, and the groove; and the rotor comprises a rotor iron hoop, the rotor iron hoop is made of a compound material, a non-magnetic material surface of the rotor iron hoop is provided with multiple rotor permanent magnets, and a metallic copper or an aluminous squirrel cage closed frame is disposed on a rotor permanent magnet surface.

2. The alternating-current full magnetic power machine according to claim 1, wherein the alternating-current full magnetic power machine has a rotary housing inner stator type structure or a fixed housing rotary inner pivot type structure.

3. The alternating-current full magnetic power machine according to claim 2, wherein the alternating-current full magnetic power machine of the rotary housing inner stator type structure comprises the stator composite magnetic head, an empty mandrel, the rotor iron hoop, the rotor the permanent magnets, and a rotating housing, the stator has three phases of independent windings, each winding comprises multiple coils, the coils are built in a cable trough of the stator iron core in sequence, the pole surface of the stator iron core surrounded by the coils is provided with a U-shaped groove, the stator permanent magnet is disposed in the groove, there is a void between the stator permanent magnet in the groove and a groove wall, glue is injected into the void for fixation and encapsulation, a stator permanent magnet of a like polarity is disposed in a same groove, and a length of the stator permanent magnet is less than a length of the groove, a pole surface of the groove is fixed with the metal-plate of a fence-like mesh structure, and the metal-plate has a thickness of 0.3 to 5 mm; another side of the stator iron core is disposed on a stator iron hoop, a wheel center of the stator iron hoop is provided with the empty mandrel, a central spindle of the empty mandrel is provided with a threading hole, two ends of the empty mandrel are provided with a bearing and are connected to a rotating housing by using the bearing, the rotating housing covers an outside of the rotor iron hoop, and in addition, one side-end of the rotating housing is fixedly connected to an output shaft; the rotor permanent magnets form a closed circle or a fold circle, wherein rotor the permanent magnets forming the fold circle are of opposite polarities and side lengths of two permanent magnets of each unit are not equal; and a length of each rotor permanent magnet is not equal to a length of a corresponding stator permanent magnet, there is an air gap between the rotor permanent magnet and a stator permanent magnet surface, and when the stator coil is conducted, strength of an inductive magnetic field generated by the stator iron core pole surface is not greater than coercivity of the surrounded stator permanent magnet.

4. The alternating-current full magnetic power machine according to claim 2, wherein the alternating-current full magnetic power machine of a fixed housing rotary inner pivot type structure comprises the stator composite magnetic head, a spindle, the rotor iron hoop, and the rotor permanent magnet, the stator has three phases of independent windings, each winding comprises multiple coils, the coils are built in the cable trough of the stator iron core in sequence, the pole surface of the stator iron core surrounded by the coils is provided with the U-shaped groove, the stator permanent magnet is disposed in the groove, there is a void between the stator permanent magnet in the groove and a groove wall, glue is injected into the void for fixation and encapsulation, a stator permanent magnet of a like polarity is disposed in a same groove, and a length of the stator permanent magnet is less than a length of the groove, and a pole surface of the groove is fixed with the metal-plate of a fence-like mesh structure; and there is an air gap between the rotor permanent magnet and a stator permanent magnet surface, a wheel center of the rotor iron hoop is disposed with the spindle, two ends of the spindle are provided with a bearing and are connected to a stator housing by using the bearing, and another side of the stator iron core is disposed on an inner wall of the stator iron hoop.

5. The alternating-current full magnetic power machine according to claim 3, wherein the alternating-current full magnetic power machine of the rotary housing inner stator type structure forms different types because of different connection configuration items of the rotating housing: if a tire is disposed on the rotating housing, a vehiculary stock alternating-current magnetic power machine is formed; if a gear or a belt pulley is disposed on the rotating housing, a mechanical equipment straight driving force alternating-current magnetic power machine is formed; and if an output shaft, a support, and a housing shield are disposed on the rotating housing, a spindle output-type alternating-current magnetic power machine applicable to an ordinary machine and tool is formed.

6. The alternating-current full magnetic power machine according to claim 1, wherein the alternating-current magnetic power machine is powered by a commercially-available alternating-current power supply, or is powered by a matching alternating-current power supply that is provided by a battery pack by using a voltage-regulating converter, and the battery pack is charged by a commercially-available power supply, or is charged by a solar battery, or is charged, after rectification and voltage regulation, by an electric generator driven by the alternating-current magnetic power machine.
